(19) United States
(12) Patent Application Publication
(10) Pub. No.: US 2016/0307215 A1
(43) Pub. Date: Oct. 20, 2016

(54) SERVER AND METHOD FOR DETERMINING ATTRIBUTE INFORMATION OF CUSTOMER BY THE SAME

(71) Applicant: TOSHIBA TEC KABUSHIKI KAISHA, Tokyo (JP)

(72) Inventor: Takahiro Kogoshi, Sunto (JP)

(21) Appl. No.: 15/099,761

(22) Filed: Apr. 15, 2016

(30) Foreign Application Priority Data
Apr. 17, 2015 (JP) 2015-085317

(51) Int. Cl. G06Q 30/02

(52) U.S. Cl. CPC G06Q 30/0201

(57) ABSTRACT

A server comprises a storage section configured to store for each attribute a behavior pattern, which characteristically represents a behavior of a customer who visits a store by an attribute of the customer, a measurement module configured to measure the behavior of the customer in the store based on an image of the customer captured by a camera arranged in the store, a reception module configured to receive an inquiry of the attribute of the customer from a sales processing apparatus which executes a transaction processing on a sales object sold to a customer in the store, and an attribute determination module configured to determine, if the inquiry is received by the reception module, the attribute of the customer by comparing the behavior of the customer measured by the measurement module with the behavior pattern stored in the storage section.

### CROSS-REFERENCE TO RELATED APPLICATION

This application is based upon and claims the benefit of priority from Japanese Patent Application No. 2015-085317, filed Apr. 17, 2015, the entire contents of which are incorporated herein by reference.

### FIELD

Embodiments described herein relate generally to a server and a method for determining attribute information of a customer who visits a store by the server.

### BACKGROUND

In a retail store such as a convenience store, there is a case in which attribute information indicating an attribute such as a gender, age bracket and the like of a customer who purchases commodity is determined to carry out a clientele analysis, a commodity sales analysis and the like. The attribute information of the customer who executes a transaction is determined by analyzing an image of the customer captured by a camera mounted on a POS (Point of Sales) terminal or fixed on the ceiling of the store.

Incidentally, it is necessary to photograph the face of the customer from the front of the customer so that the attribute information is certainly determined from the image of the customer. However, in a case in which the customer does not face the camera directly, or in a case in which the customer wears a mask or hat even if he/she faces the camera directly, there is a possibility that the attribute information of the customer cannot be acquired from the image captured in such a situation as described above.

### DESCRIPTION OF THE DRAWINGS

FIG. 1 is a diagram schematically illustrating cameras, a POS terminal and a server which are arranged in a store;

FIG. 2 is a schematic plan view illustrating a state in which the POS terminal of the embodiment is arranged in the store when viewed from the upper side;

FIG. 3 is an external perspective view illustrating the POS terminal of the embodiment when viewed from the customer side;

FIG. 4 is a block diagram illustrating the hardware structure of the POS terminal;

FIG. 5 is a memory map illustrating an example of a face master file in the POS terminal;

FIG. 6 is a block diagram illustrating the hardware structure of the server;

FIG. 7 is a memory map schematically illustrating an example of an attribute storage section of the server;

FIG. 8 is a memory map schematically illustrating an example of a flow-line section of the server;

FIG. 9 is a memory map schematically illustrating an example of a shop arrival time section of the server;

FIG. 10 is a memory map schematically illustrating an example of a staying time section of the server;

FIG. 11 is a flowchart illustrating the flow of a control processing of the POS terminal;

FIG. 12 is a flowchart illustrating the flow of a face detection thread of the POS terminal;

FIG. 13 is a flowchart illustrating the flow of an inquiry thread of the POS terminal;

FIG. 14 is a functional block diagram illustrating functional components of the server;

FIG. 15 is a flowchart illustrating the flow of a control processing of the server; and

FIG. 16 is a flowchart illustrating the flow of a control processing of the server.

### DETAILED DESCRIPTION

In accordance with an embodiment, a server comprises a storage section configured to store for each attribute a behavior pattern which characteristically represents a behavior of a customer who visits a store by an attribute of the customer, a measurement module configured to measure the behavior of the customer in the store based on an image of the customer captured by a camera arranged in the store, a reception module configured to receive an inquiry of the attribute of the customer from a sales processing apparatus which executes a transaction processing on a sales object sold to a customer in the store, and an attribute determination module configured to determine the attribute of the customer by comparing the behavior of the customer measured by the measurement module with the behavior pattern stored in the storage section if the inquiry is received by the reception module.

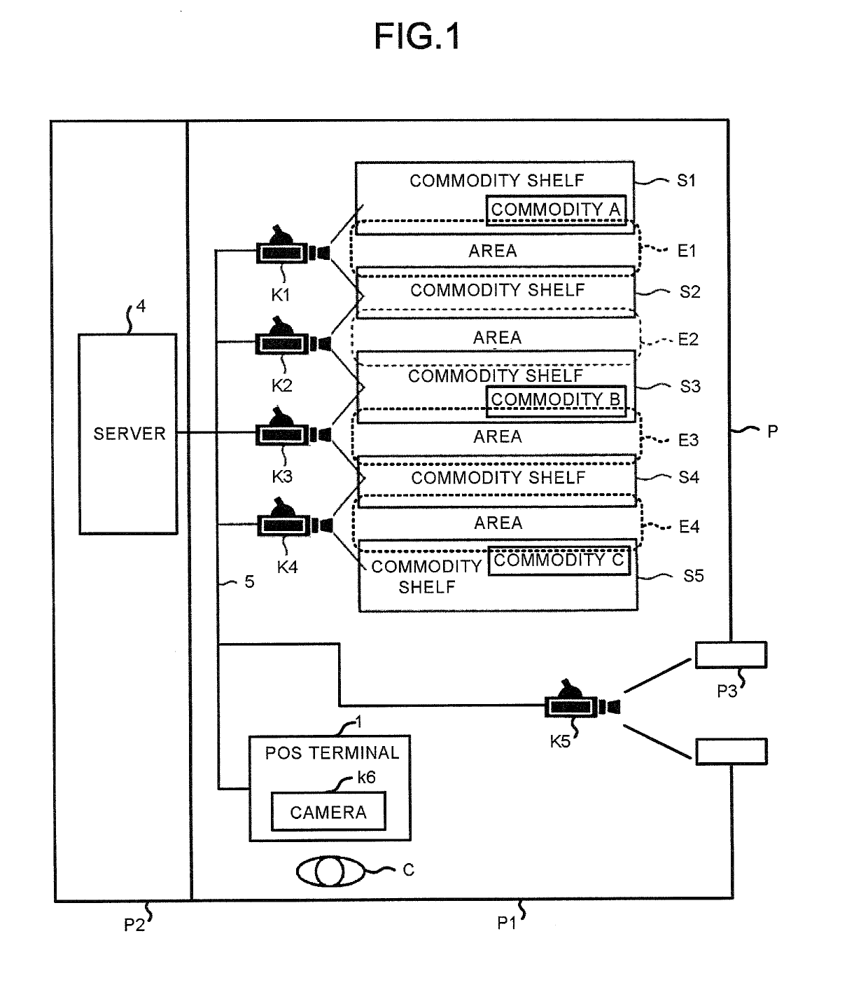

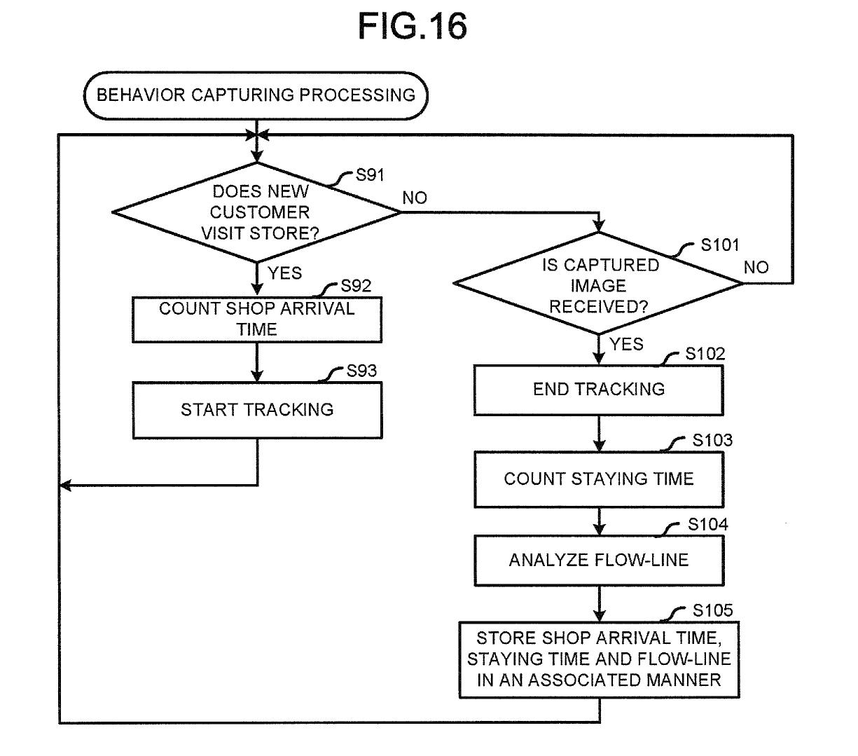

Hereinafter, a server according to the embodiment is described in detail with reference to FIG. 1˜FIG. 16. In the present embodiment, a commodity is described as an example of the sales object. Furthermore, this invention is not limited by the embodiment described below.

FIG. 1 is a schematic plan view illustrating cameras, a POS terminal 1 and a server 4 which are arranged in a store such as a convenience store according to the embodiment. In FIG. 1, a store P has a sales area P1 where commodities are sold and an office area P2 serving as a back office. An entrance P3 through which a customer enters or leaves the store is arranged in the sales area P1. Further, a plurality of rows of shelves S (S1˜S5), cameras K (K1˜K6) and the POS terminal 1 are arranged in the sales area P1. A reference character ‘ S’ is used to represent the shelves collectively while reference characters ‘S1˜S5’ are used to represent the shelves separately. A reference character ‘K’ is used to represent the cameras collectively while reference characters ‘ K1˜K5’ are used to represent the cameras separately. The server 4 is arranged in the office area P2.

The POS terminal 1, the cameras K1˜K5 and the server 4 are electrically connected with each other via a communication line 5. The camera K6 is arranged inside the POS terminal 1.

Each shelf S includes a plurality of shelf-parts, and a large number of commodities are displayed on each shelf-part. Areas E (E1˜E4) are respectively arranged between two adjacent shelves S. A reference character “E” is used to represent the areas collectively while reference characters “E1˜E4” are used to represent the areas individually. The area E, which is arranged between the shelves, is a space enough for the customer C to pass through. The customer C can see commodities displayed on the shelf S or put commodities in a basket or a shopping cart from the shelf to purchase them while walking through the area E.

The cameras K1′K5 are arranged on the ceiling of the sales area P1 of the store P. The cameras K1˜K5 are arranged in such a manner that they are directed from the ceiling toward the entrance P3 and the area E respectively. The cameras K1˜K5, constituted with a CCD, are used to capture continuous still images or motion images (collectively referred to as “images”) of a photographed object such as the customer C. In the present embodiment, the cameras K1˜K5 capture, for example, 10 continuous still images per second of the customer C who enters the store from the entrance P3 and passes through the area E.

The camera K1 captures images of a face and clothes of the customer C who passes through the area E1. The camera K2 captures images of a face and clothes of the customer C who passes through the area E2. The camera K3 captures images of a face and clothes of the customer C who passes through the area E3. The camera K4 captures images of a face and clothes of the customer C who passes through the area E4. The camera K5 captures images of a face and clothes of the customer C who enters the store P from the entrance P3. The camera K6 captures images of a face and clothes of the customer C who executes a transaction processing through the POS (Point of Sales) terminal 1. These images of the face and clothes of the customer C captured by these cameras K are referred to as captured images. The cameras K1˜K6 captures the inside of the store exhaustively, and in this way, all behavior tracks in the store of the customer C who enters the store P can be captured in a trackable manner.

Each POS terminal 1 is arranged in the sales area P1 of the store P. Each POS terminal 1 is electrically connected with the server 4 via the communication line 5 such as a LAN (Local Area Network). In FIG. 1, only one POS terminal 1 is arranged, but the number of the POS terminals 1 is not limited to 1.

The POS terminal 1 carries out a sales registration processing relating to sales of commodities displayed in the store. An operator CH operates the POS terminal 1, and in this way, the POS terminal 1 executes a sales registration processing and a settlement processing on the sold commodities. The sales registration processing refers to a processing of optically reading a code symbol such as a barcode attached to a sold commodity and then inputting the commodity code, displaying a commodity name, a price and the like (commodity information) of the commodity read from a file based on the input commodity code, and storing the commodity information in a buffer. The settlement processing refers to, based on the commodity information stored in the buffer along with the sales registration processing, a processing of displaying a total amount relating to the transaction, calculating and displaying a change amount on the basis of a deposit amount received from the customer C, a processing of instructing a change dispensing machine to discharge change amount, and a processing of issuing a receipt on which the commodity information and settlement information (the total amount, the deposit amount, the change amount, etc.) are printed. Further, the sales registration processing and the settlement processing are collectively referred to as a transaction processing.

The camera K6 is arranged in the POS terminal 1 as described above. The camera K6 photographs the face and clothes of the customer C who purchases commodities to which a transaction processing is carried out by the POS terminal 1. The POS terminal 1 determines an attribute (gender, age bracket, etc.) of the customer C from the face of the customer C photographed by the camera K6. The POS terminal 1 sends attribute information indicating the determined attribute in association with the commodity information of the commodities purchased by the customer C to the server 4. Further, the POS terminal 1 sends the captured image of the customer C by the camera K6 to the server 4.

The server 4 is electrically connected with the POS terminal 1 via the communication line 5. The server 4 totalizes the commodity information (sales object information) and the settlement information of the sold commodities with the POS terminal 1 and stores the totalized information. The server 4 sends the commodity information and the settlement information collected from the POS terminal 1 to a headquarters server (not shown) arranged in the headquarters.

The server 4 updates an attribute ratio of the attribute received corresponding to the commodity to the latest one based on the related information of the commodity information and the attribute information received from the POS terminal 1. The manager of the store P uses information indicating the latest attribute ratio in the store operation.

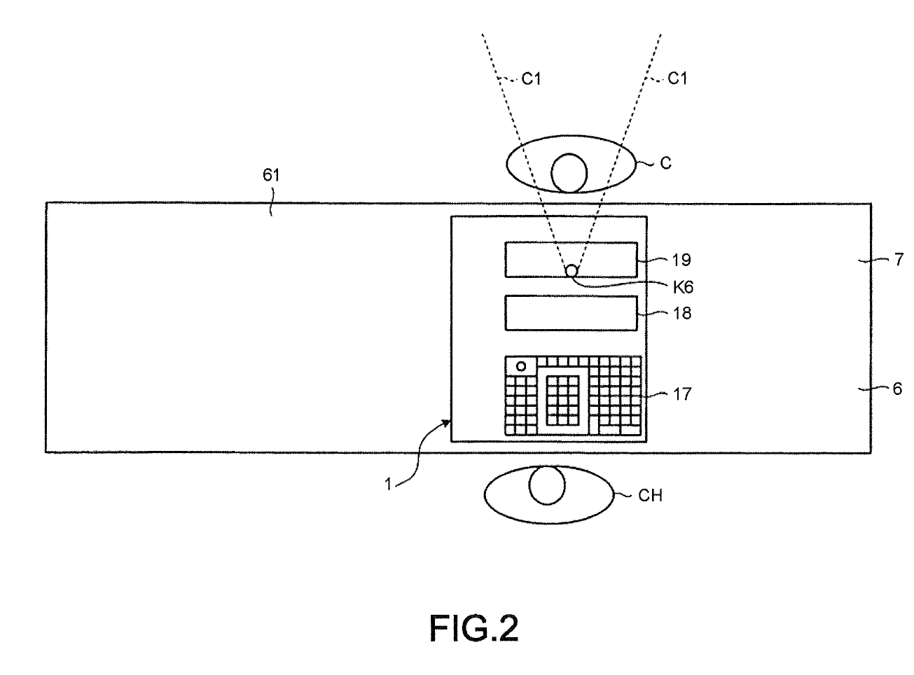

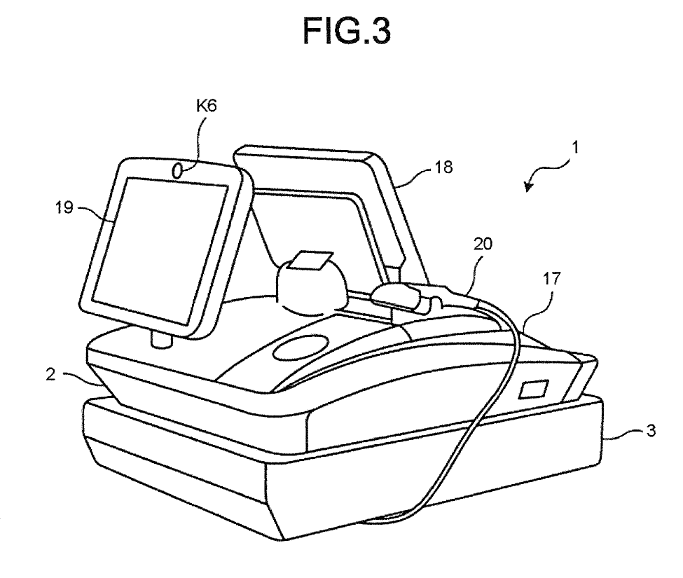

FIG. 2 is a schematic plan view illustrating the POS terminal 1 arranged in the store. A settlement or checkout location is arranged in the store P to settle the commodities purchased in the store P. FIG. 2 illustrates one of a plurality of rectangular counters 6 arranged in the checkout location. A flat plane 7 where the POS terminal 1 is arranged is formed on the top surface of the counter 6. The operator CH is positioned at the operation side of the POS terminal 1, and the customer C is positioned at the passage side which is opposite to the operation side across the counter 6. The customer C places a basket in which a commodity to be purchased is put on a placing section 61 of the counter 6. The operator CH takes out the commodity from the basket placed on the placing section 61, and optically reads a code symbol attached to the commodity with a reading section 20 (refer to FIG. 3). In this way, the POS terminal 1 executes the sales registration processing and the settlement processing on the commodity.

The POS terminal 1, which will be described in detail with reference to FIG. 3, comprises an operation section 17 such as a keyboard operated by the operator CH, a display section for operator 18 for displaying information to the operator CH and a display section for customer 19 for displaying information to the customer C.

A camera K6 is arranged on the upper part of the outer frame of the display section for customer 19. The camera K6 is constituted with a CCD (Charge Coupled Device) image sensor and the like. The camera K6 is arranged toward the customer C side, so that the customer C who is located in an area surrounded by C1 at the customer C side of the POS terminal 1 can see the display of the display section 19. The camera K6 can photograph the customer C who is located at a position where the customer C can directly face the camera K6 surrounded by C1.

The camera K6 captures a motion image or continuous still images (collectively referred to as “image”) of the face and clothes of the customer C who purchases the commodities to which the transaction processing is carried out by the POS terminal 1. In the present embodiment, the camera K6 captures, for example, 10 images of the customer C per second. The image captured by the camera K6 is referred to as a captured image.

FIG. 3 is an external perspective view illustrating the POS terminal 1 of the embodiment when viewed from the customer C side. In FIG. 3, the POS terminal 1 includes a main body 2 and a cash box 3. The cash box 3 with a drawer stores cash such as bills and coins and securities (valuable paper) such as a gift voucher received from the customer C, and change to be handed over to the customer C.

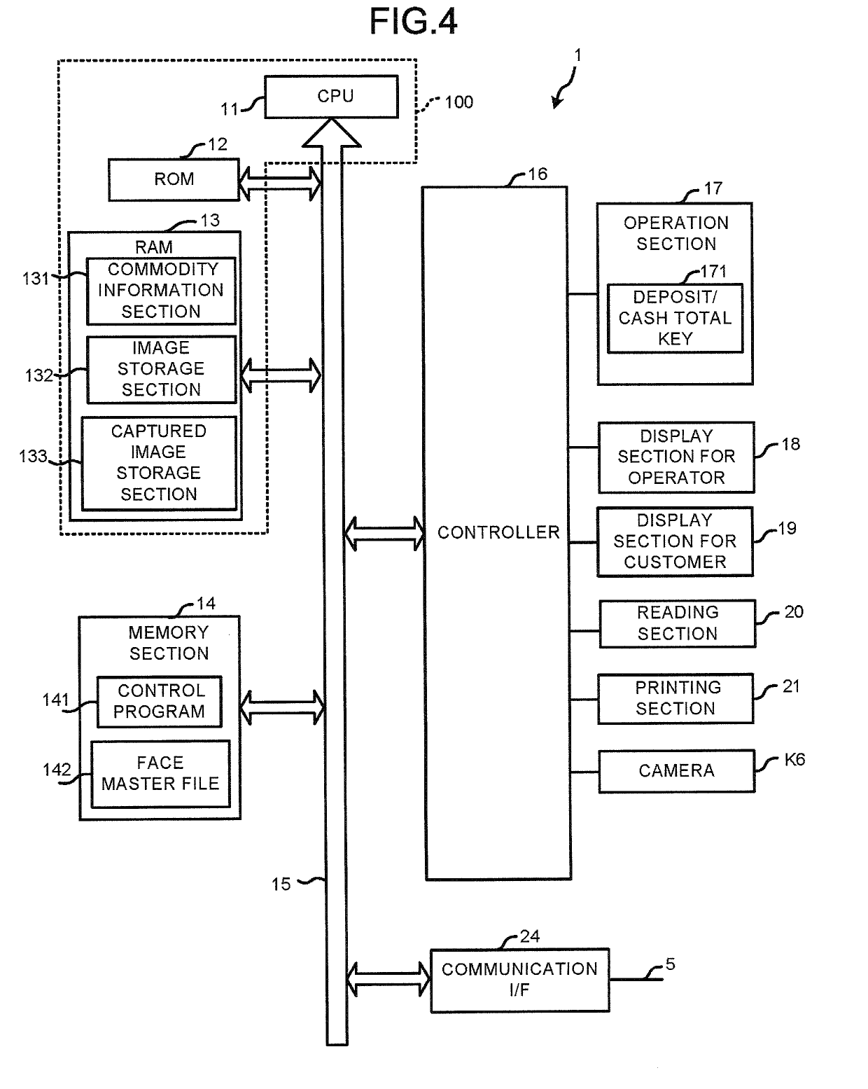

The main body 2 includes the operation section 17 such as a keyboard for inputting information, the display section for operator 18, e.g., a liquid crystal display, used to display information to the operator, and the display section for customer 19, e.g., a liquid crystal display, used to display information to the customer C. Further, the main body 2 is equipped with the reading section 20 to read a code symbol such as a barcode, a two-dimensional code and the like attached to a commodity. The reading section 20 reads the code symbol attached to the commodity with the CCD image sensor to input it to the POS terminal 1. The main body 2 is also equipped therein with a control section 100 (refer to FIG. 4) of the POS terminal 1 and a printing section 21 which is used for printing the commodity information to issue a receipt.

Furthermore, the camera K6 is arranged on the center of the upper part at the display surface side of the display section for customer 19 of the POS terminal 1.

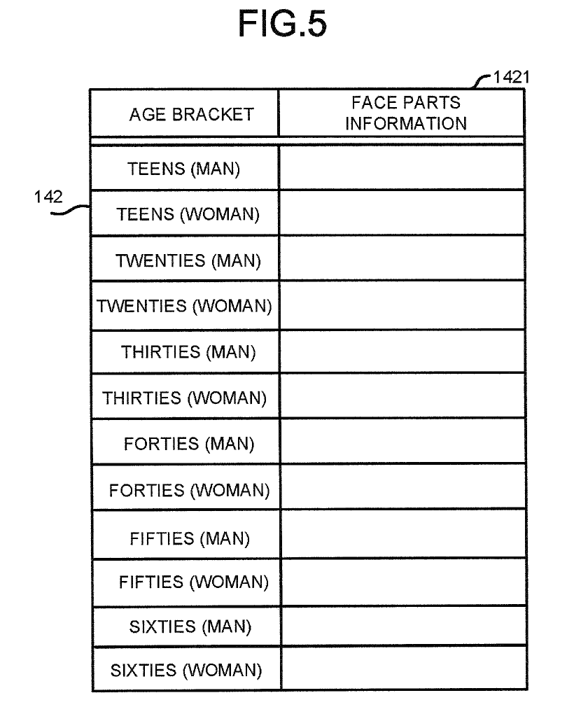

Next, the hardware of the POS terminal 1 is described with reference to FIG. 4 and FIG. 5. FIG. 4 is a block diagram illustrating the hardware structure of the POS terminal 1. In FIG. 4, the POS terminal 1 comprises a CPU (Central Processing Unit) 11, a ROM (Read Only Memory) 12, a RAM (Random Access Memory) 13, a memory section 14 and the like. The CPU 11 acts as a main part of control. The ROM 12 stores various kinds of programs. The RAM 13 copies or decompresses programs and various data. The memory section 14 stores various kinds of programs. The CPU 11, the ROM 12, the RAM 13 and the memory section 14 are connected with each other via a data bus line 15. The CPU 11, the ROM 12 and the RAM 13 constitute the control section 100. The CPU 11 operates according to a control program 141, stored in the ROM 12 or the memory section 14, which is copied or decompressed on the RAM 13, and thus, the control section 100 executes a control processing described later.

The RAM 13 comprises a commodity information section 131, an image storage section 132 and a captured image storage section 133. The commodity information section 131 stores commodity information (a commodity code, a commodity name, a price and the like) of a commodity to which the sales registration processing is carried out in association with the commodity code read by the reading section 20. The image storage section 132 stores an image of the customer C of whom the face is detected from an image captured by the camera K6. The face detection technology for detecting a face is a well-known technology for detecting a face of a person by detecting all under-mentioned parts (eyes, nose, mouth, ears, jaw and the like) of a face from the image captured by the camera K6. Further, the captured image storage section 133 stores the image of the customer captured by the camera K6.

The memory section 14, which is a non-volatile memory such as an HDD (Hard Disc Drive) or a flash memory in which the stored information can be held even if the power supply is cut off, stores programs including the control program 141. The memory section 14 also includes a face master file 142 (refer to FIG. 5).

The operation section 17, the display section for operator 18, the display section for customer 19, the reading section 20, the printing section 21 and the camera K6 are connected to the data bus 15 via a controller 16. The controller 16 receives an instruction from the control section 100 to control the operation section 17, the display section for operator 18, the display section for customer 19, the reading section 20, the printing section 21 and the camera K6. To simply the description, the control operation carried out by the controller 16 is only described as that carried out by the control section 100.

The operation section 17 comprises various keys including numeric keys, function keys and the like. A subtotal key (not shown) is operated to declare the start of a settlement processing after a sales registration processing on a purchased commodity is ended. If the subtotal key is operated, the settlement processing of this transaction is started. A deposit/cash total key 171 is used for performing a settlement processing on the transaction with cash while declaring the ending of the transaction. If the deposit/cash total key 171 is operated, a settlement processing with cash is executed to end the transaction processing.

The display surface of the display section for operator 18 is arranged such that it is directed to the operator CH to display information to the operator. The display surface of the display section for customer 19 is arranged such that it is directed to the customer C to display information to the customer C. Touch keys (not shown), acting as an input key by touching, which are arranged on the display section for operator 18 and the display section for customer 19 respectively, are part of the operation section 17.

The reading section 20 constituted with the CCD image sensor reads a code symbol such as a barcode or a two-dimensional code attached to the commodity with the CCD image sensor to input the commodity code represented with the code symbol. In the present embodiment, the operator closes or contacts the hand-held reader (reading section 20) to or with the code symbol attached to the commodity to read the code symbol. Further, the reading section 20 may be a scanner which emits light to scan the code symbol with a polygonal mirror and receives the light reflected from the code symbol.

The printing section 21 includes, for example, a thermal printer provided with a thermal transfer type print head. The printing section 21 takes out a rolled receipt paper housed in the main body 2 and prints commodity information and settlement information on the receipt paper to issue the printed paper as a receipt. The camera K6 constituted with a CCD captures an image including the clothes the customer C wears and the face of the customer C who executes the transaction.

Further, the data bus line 15 connects with a communication I/F (Interface) 24 that is electrically connected with the server 4 arranged in the store. The communication I/F 24 is connected to the communication line 5. The server 4 is electrically connected with all the POS terminals 1 arranged in the store to collect commodity information and settlement information from these POS terminals 1. The store server sends the commodity information and the settlement information collected from the POS terminals 1 to the headquarters server (not shown) arranged in the headquarters.

FIG. 5 is a memory map illustrating the face master file 142 of the memory section 14. In FIG. 5, the face master file 142 includes face parts information sections 1421 for storing face parts information for each gender and each age bracket from teens to over 60 years old. Each face parts information section 1421 stores the face parts information which can specify the attributes (age bracket and gender) of a customer, respectively.

The face parts information refers to data, obtained by classifying a human face in accordance with parts and features, which indicates each part and feature of each attribute, for example, data representing features of parts containing eyes, nose, mouth, ears, and jaw of a person, and facial deformation features containing a smiling face, a solemn face, a face with closed eyes and a face with opened eyes. The face parts information stored for each attribute represents features of the attribute different from other attributes. For example, in a face parts information section 1421 for male in their teens, information of eyes, nose, mouth and ears indicating the features of male in their teens and information of a smiling face and a solemn face indicating the features of male in their teens are stored. This face parts information for the each attribute created based on a large amount of statistical data can represent the attribute markedly.

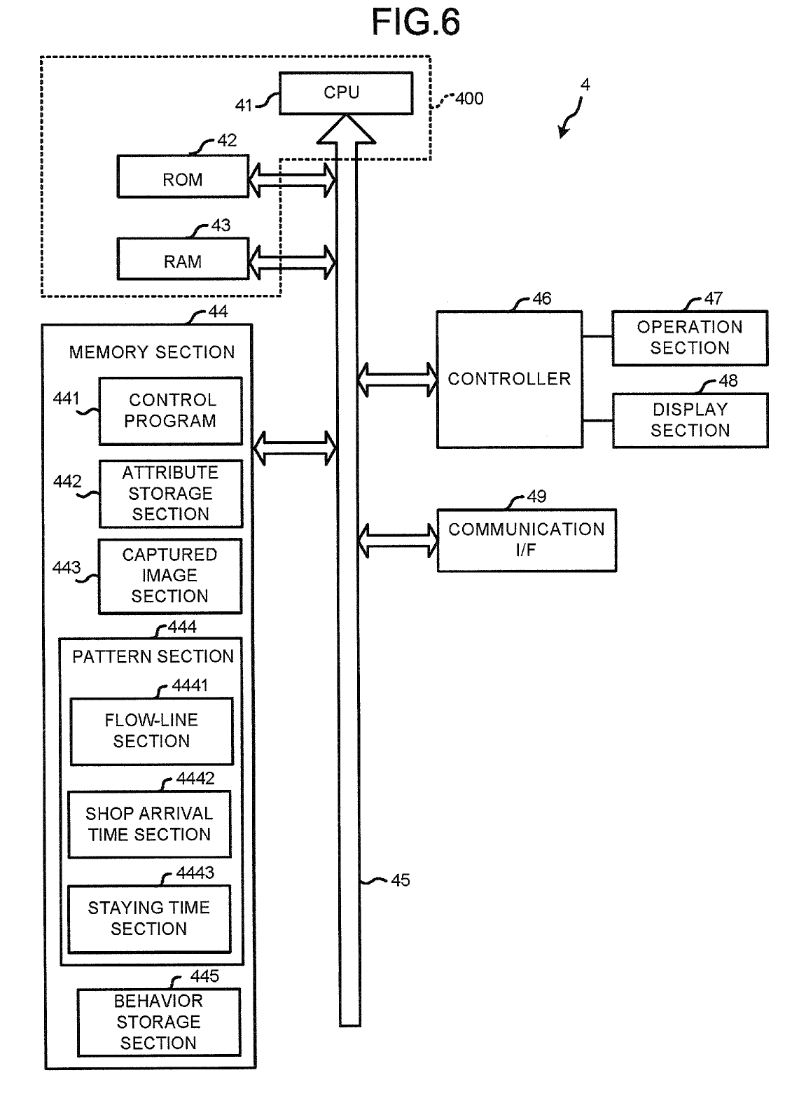

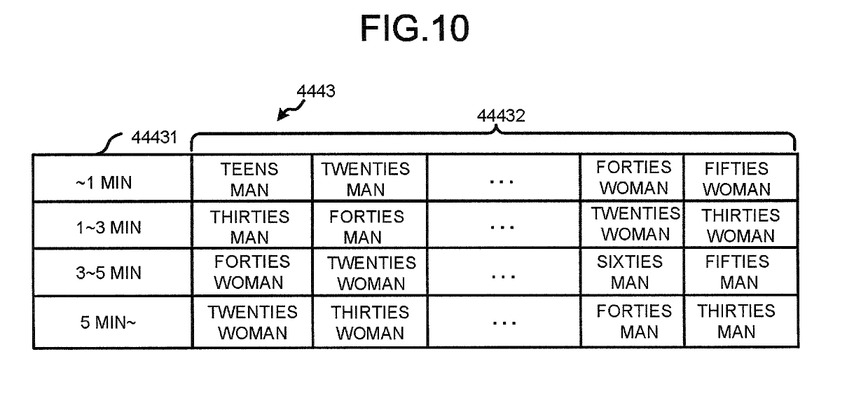

Next, the hardware of the server 4 is described with reference to FIG. 6˜FIG. 10. FIG. 6 is a block diagram illustrating the hardware structure of the server. In FIG. 6, the server 4 comprises a CPU 41 serving as a main part of control, a ROM 42 storing various kinds of programs, a RAM 43 on which various data are copied or decompressed, a memory section 44 storing various kinds of programs and the like. The CPU 41, the ROM 42, the RAM 43 and the memory section 44 are connected with each other via a data bus line 45. The CPU 41, the ROM 42 and the RAM 43 constitute the control section 400. The CPU 41 operates according to a control program, stored in the ROM 42 or the memory section 44, which is copied or decompressed on the RAM 43, and thus, the control section 400 executes a control processing described later.

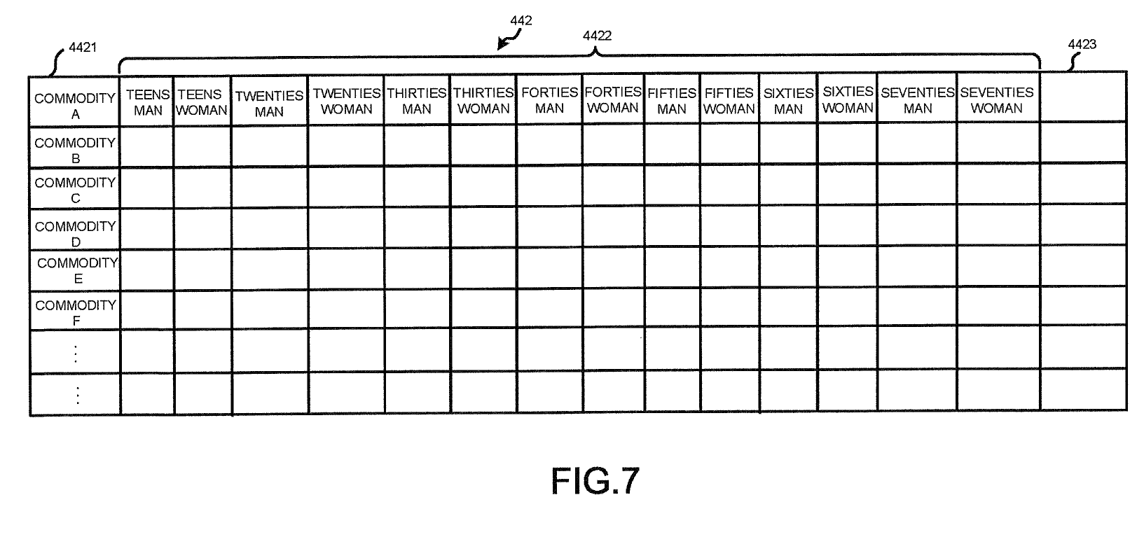

The memory section 44, which is a non-volatile memory such as an HDD (Hard Disc Drive) or a flash memory in which the stored information can be held even if the power supply is cut off, stores programs including the control program 441. The memory section 44 also comprises an attribute storage section 442 (refer to FIG. 7) and a captured image section 443. The captured image section 443 stores captured images, received from the POS terminal 1, which are captured by the camera K6.

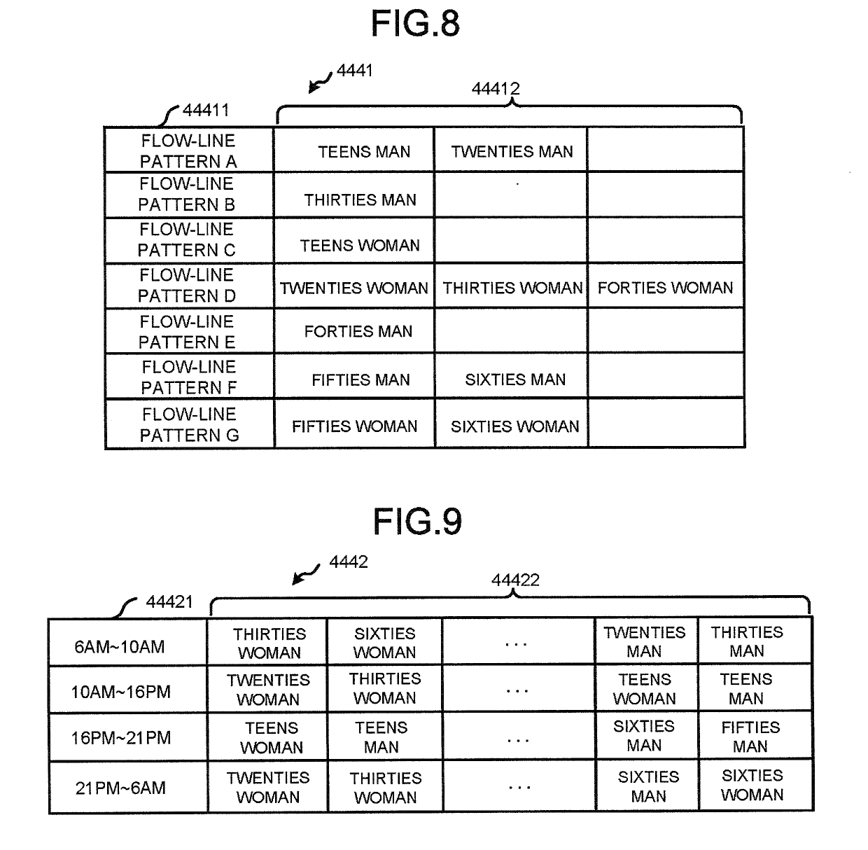

Further, the memory section 44 comprises a pattern section 444 (storage section). The pattern section 444 stores information obtained by characteristically patterning tracks of behavior of the customer C in the store P in association with the attributes. The pattern section 444 comprises a flow-line section 4441 (refer to FIG. 8), a shop arrival time section 4442 (refer to FIG. 9) and a staying time section 4443 (refer to FIG. 10).

The memory section 44 further comprises a behavior storage section 445. The behavior storage section 445 stores behavior information relating to behaviors of customers C who enter the entrance P3 for each customer C. Specifically, the behavior storage section 445 stores information of flow-line, shop arrival time and staying time serving as behavior information of the customers C who enter the store P from the entrance P3 in association with each customer C.

The flow-line is behavior tracks of the customer C in the store from a moment when the customer C enters the store to a moment when the customer C executes a transaction processing with the POS terminal 1. The camera K5 captures the image of the customer C who enters the store. Then, the cameras K1˜K4 photographs the behavior of the customer C in the store. The camera K6 captures the image of the customer C who carries out the transaction processing with the POS terminal 1. Flow-lines measured based on the images of the customer C captured by each camera K are stored in the behavior storage section 445.

The flow-line measurement technology is a well-known technology in which images of a person captured by a security camera are analyzed to trace the behaviors of the person, and then the track (result of the trace) is represented by lines. Specifically, a face recognition operation is executed based on the captured face information (eyes, nose, mouth, jaw, etc.) to determine identity of a person, and further the identity of the person is determined based on the consistency of color and shape of the clothes (coat, trousers, hat and the like) the person is wearing. If the behavior of a person whose consistency is determined is continuously measured in time series, it is possible to grasp the continuous tracks (flow-line) of behavior of the person in the store.

The shop arrival time of a new customer C who enters the store is stored in the behavior storage section 445 based on the image of the customer C captured by the camera K5.

The staying time from a moment when the customer C enters the store to a moment when the customer C carries out a transaction processing with the POS terminal 1 is stored in the behavior storage section 445.

For the same customer C, the flow-line, the shop arrival time and the staying time are stored in the behavior storage section 445 in association with one another. If a customer C is specified, the flow-line, the shop arrival time and the staying time of the customer C can be acquired.

Furthermore, an operation section 47 and a display section 48 are connected to the data bus line 45 via a controller 46. The operation section 47 is a keyboard which comprises keys for performing various operations. The display section 48 is, for example, a liquid crystal display which displays information. A communication I/F 49 is connected to the data bus line 45. The communication I/F 49 is electrically connected to the POS terminal 1 through the communication line 5.

FIG. 7 is a diagram illustrating the attribute storage section 442. The attribute storage section 442 totalizes commodity information of commodities (commodities purchased by the customer C) to which the sales registration processing is carried out with the POS terminal 1 in association with the attributes of the customer C who purchased the commodities for each attribute (gender, age bracket, etc.) and stores the totalized commodity information by the attributes. Based on the commodity information stored in the attribute storage section 442, it is possible to analyze the tendency or trend of purchasing commodity by attributes.

The attribute storage section 442 includes a commodity information section 4421, an attribute ratio section 4422 and an unknown information section 4423. The commodity information section 4421 stores commodity codes for specifying the commodities purchased by the customer C. The attribute ratio section 4422 stores attribute ratios for each attribute corresponding to the commodity codes respectively.

The attribute ratio section 4422 stores an attribute ratio indicating a purchase rate of a commodity by an attribute (gender, age bracket and the like) of a person who purchases the commodity corresponding to the commodity code indicating the sold commodity. Specifically, the attribute ratio section 4422 stores purchase quantity of a commodity by an attribute of a person who purchases the commodity corresponding to the commodity code indicating the sold commodity. Then, the attribute ratio section 4422 stores the rate (attribute ratio) obtained by dividing the purchase quantity of a commodity by each attribute by the total purchase quantity of the commodity.

For example, the attributes of people who purchase a commodity A are stored as follows: the rate of male in their twenties is 20%, the rate of female in their twenties is 25%, the rate of male in their thirties is 10%, the rate of female in their thirties is 15% . . . . The rates such as 20%, 25%, 10%, and 15% serving as attribute ratios refer to the rate of each attribute among the people who purchase the commodity A. The attribute whose attribute ratio is higher represents that the purchase rate of the commodity A is higher. That is, the attribute whose attribute ratio is high represents that the customers who belong this attribute purchase many of the commodities A. The attribute ratios of a commodity B and a commodity C are also stored similarly.

Further, the attribute ratio section 4422 stores the quantity of unknown attributes by each attribute. In a case in which the face of the customer C who purchases commodities cannot be detected in a sales registration processing, the unknown attribute indicates that the attribute received from the POS terminal 1 is unknown corresponding to the commodity information of the commodities purchased by the customer C.

In a case in which the unknown information is received from the POS terminal 1 together with the commodity information, the unknown information section 4423 stores the quantity of the received unknown information corresponding to the commodity information. The quantity of the received unknown information is increased by one every time the unknown information is received. Further, every time an under-mentioned attribute is extracted, the quantity of the received unknown information is decreased by one.

FIG. 8 is a diagram illustrating the flow-line section 4441. The flow-line section 4441 stores a pattern of a flow-line indicating a continuous behavior track of the customer C who visits the store P from the entrance P3 to the POS terminal 1, corresponding to each attribute. The customer C is known by showing different characteristic flow-lines for each attribute. The flow-line section 4441 stores one or more flow-line patterns characteristically representing the behavior of the customer having an attribute in the store, corresponding to the attribute based on the past statistics.

In FIG. 8, the flow-line section 4441 includes a flow-line pattern section 44411 and an attribute section 44412. The flow-line pattern section 44411 stores different characteristic flow-line patterns (behavior patterns) of the customers in the store P by different attributes respectively. The attribute section 44412 stores an attribute which tends to behave like a flow-line pattern, corresponding to the flow-line pattern stored in the flow-line pattern section 44411. In a case in which one attribute corresponds to one flow-line pattern, it represents that there is one attribute indicating the flow-line pattern. In a case in which a plurality of attributes corresponds to one flow-line pattern, it represents that there is a plurality of attributes indicating the flow-line pattern.

Further, the flow-line section 4441 stores different flow-line patterns in spring, summer, autumn and winter respectively. This is because that the behavior of the customer C of each attribute tends to change according to the season, weather and the like. For example, in summer, there is a tendency that mainly young people purchase a soft drink. Further, in winter, there is a tendency that mainly female purchase hot food. In spring and autumn, there are also characteristic flow-line patterns respectively. Consequently, the flow-line section 4441 stores different flow-line patterns by different attributes shown in FIG. 8 respectively for each season.

Further, the flow-line section 4441 stores different flow-line patterns according to different weathers (sunny weather, cloudy weather, rainy weather, snowy weather, etc.) respectively. For example, in sunny weather and rainy weather, different flow-line patterns are stored in the same attribute respectively. This is also because that there is a tendency that flow-lines are respectively different in the same attribute depending on the weather. Consequently, the flow-line section 4441 stores different flow-line patterns by different attributes shown in FIG. 8 for each weather condition.

FIG. 9 is a diagram illustrating the shop arrival time section 4442. The shop arrival time section 4442, for the customers C who visit the store P, stores characteristic shop arrival time patterns, corresponding to attributes respectively, in which the number of customers of each attribute is the most.

In FIG. 9, the shop arrival time section 4442 includes a shop arrival time zone section 44421 and an attribute section 44422. The shop arrival time zone section 44421 stores predetermined time zones (behavior patterns). The attribute section 44422 stores attributes for each time zone in a descending order of tendency that the time zone is regarded as a shop arrival time. For example, in the time zone from 6 am to 10 am, the attribute of people who visit the store most often is female in their thirties, and the attribute next to female in their thirties in a descending order is female in their sixties. On the contrary, the attribute of people who visit the store least is male in their thirties, and the attribute next to male in their thirties in an ascending order is male in their twenties. Similarly, regarding to the time zone 10 am˜16 pm, the time zone 16 pm˜21 pm, and the time zone 21 pm˜6 am, the attributes are also stored in a descending order of tendency that the time zones are respectively regarded as a shop arrival time.

Further, the shop arrival time section 4442 stores different shop arrival time patterns in spring, summer, autumn and winter respectively. This is because that the behavior of the customer C of each attribute tends to change according to the season, weather and the like. For example, in summer there is a tendency that mainly old people visit the store at an earlier time. Further, in winter, there is a tendency that mainly female visits the store in a time zone of dusk. In spring and autumn, there are also characteristic shop arrival time patterns respectively. Consequently, the shop arrival time section 4442 stores different shop arrival time patterns by different attributes shown in FIG. 9 in each season.

Further, the shop arrival time section 4442 stores different shop arrival time patterns according to the weather conditions. For example, in sunny weather and rainy weather, different shop arrival time patterns are stored in the same attribute respectively. This is also because that there is a tendency that shop arrival time is different in the same attribute respectively according to the different weather conditions. Consequently, the shop arrival time section 4442 stores different shop arrival time patterns by different attributes shown in FIG. 9 for each weather condition.

FIG. 10 is a diagram illustrating the staying time section 4443. The staying time section 4443, for the customer C who visits the store P, stores a characteristic staying time pattern corresponding to an attribute, in which the number of customers of the attribute is the most.

In FIG. 10, the staying time section 4443 comprises a staying time zone section 44431 and an attribute section 44432. The staying time section 4443 stores predetermined staying time zones (behavior patterns) in which the customer stays in the store. The attribute section 44432 stores attributes for each staying time zone in a descending order of tendency that the staying time is matching with the staying time zone. For example, if the staying time is shorter than one minute, the attribute of which the staying time is the most matching with the staying time zone (less than one minute) is male in their teens. The attribute next to male in their teens in a descending order is male in their twenties. On the contrary, the attribute of which the staying time is the least matching with the staying time zone (less than one minute) is female in their fifties, and the attribute next to female in their fifties in an ascending order is female in their forties. Regarding to staying time 1˜3 min, staying time 3˜5 min, and staying time more than 5 minutes, the attributes are also stored in a descending order of tendency that the staying time is matching with the staying time zone.

Further, the staying time section 4443 stores different staying time patterns in spring, summer, autumn and winter respectively. This is because that the behavior of the customer C of each attribute tends to change according to the season, weather and the like. For example, in summer, there is a tendency that mainly young people stay in the store for a long time. Further, in winter, there is a tendency that mainly female stays in the store for a long time. In spring and autumn, there are also characteristic staying time patterns respectively. Consequently, the staying time section 4443 stores different staying time patterns by different attributes shown in FIG. 10 for each season.

Further, the staying time section 4443 stores different staying time patterns according to the weather conditions respectively. For example, in sunny weather and rainy weather, different staying time patterns are stored in the same attribute respectively. This is also because that there is a tendency that the staying time is different in the same attribute respectively according to the different weather conditions. Consequently, the staying time section 4443 stores different staying time patterns by different attributes shown in FIG. 10 for each weather condition.

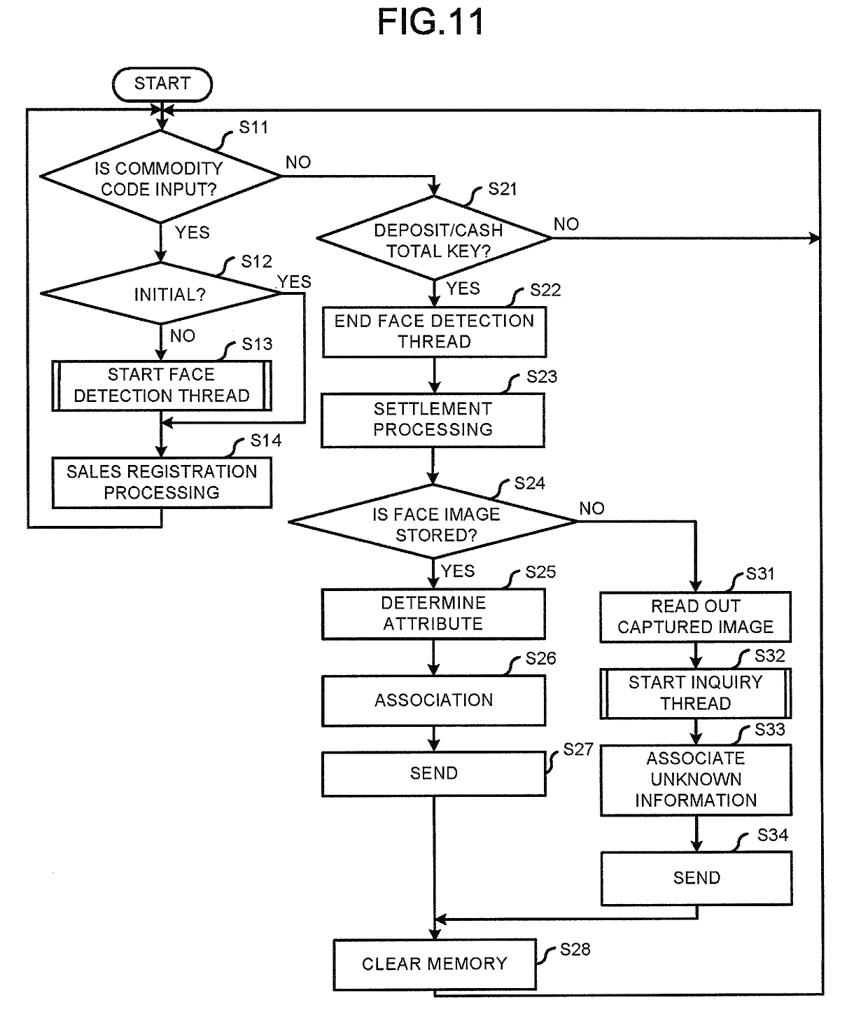

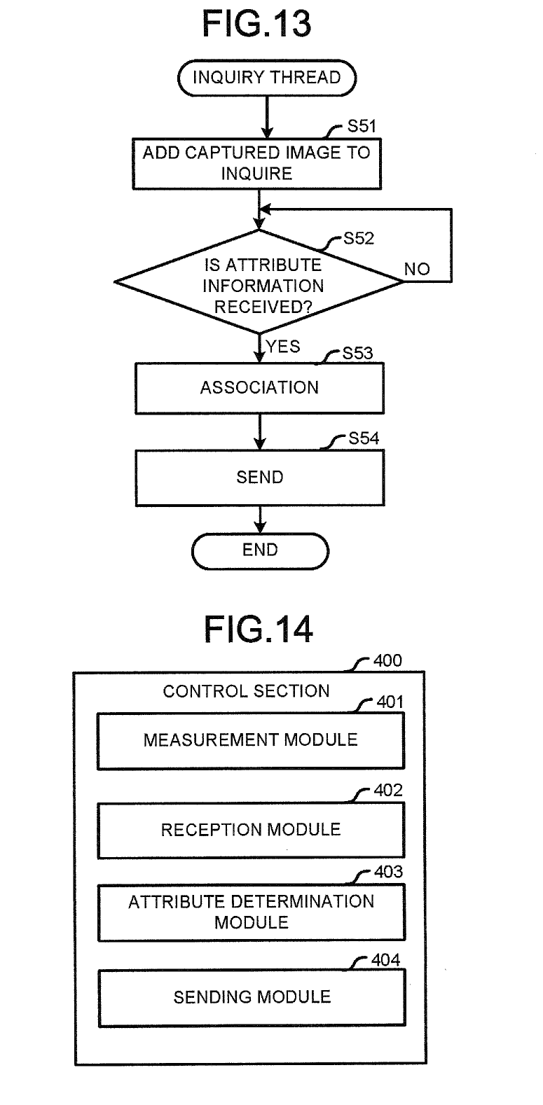

Next, a control processing carried out by the POS terminal 1 is described with reference to FIG. 11˜FIG. 13. FIG. 11 is a flowchart illustrating the flow of the control processing of the POS terminal 1. First, in FIG. 11, the control section 100 determines whether or not a commodity code is input upon reading a code symbol attached to a commodity by the reading section 20 (ACT S11). If it is determined that the commodity code is input (YES in ACT S11), the control section 100 determines whether or not the commodity code input in ACT S11 is an initially input commodity code of the commodity in this transaction (ACT S12). If the commodity information of the commodity corresponding to the commodity code is not stored in the commodity information section 131, the control section 100 determines that the commodity code is initially input in this transaction.

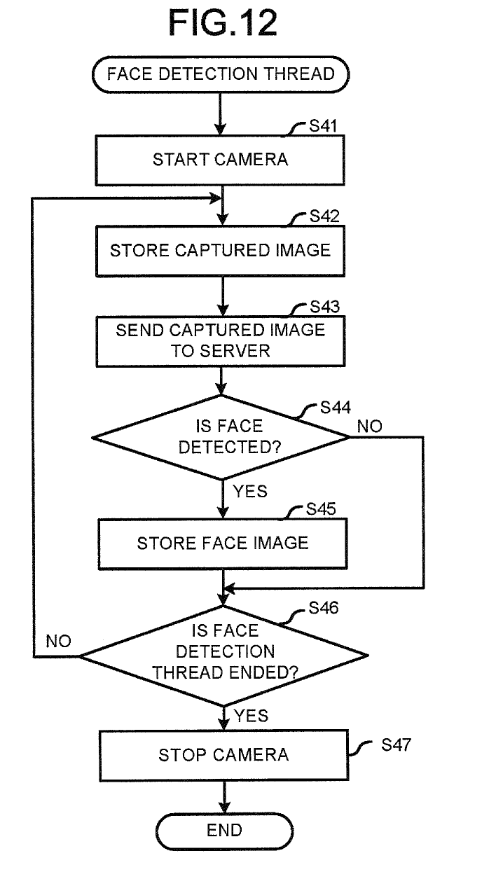

If it is determined that the commodity code is initially input in this transaction (YES in ACT S12), the control section 100 starts to execute a face detection thread (program) shown in FIG. 12 (ACT S13). Then, the control section 100 executes a sales registration processing on the commodity of which the commodity code is input in ACT S11, and stores commodity information in the commodity information section 131 (ACT S14). Then, the control section 100 returns to the processing in ACT S11. On the other hand, if it is determined that the commodity code is not initially input in this transaction (NO in ACT S12), since the face detection thread has already been started, the control section 100 executes the processing in ACT S14 without executing the processing in ACT S13.

The flow of the control processing of the face detection thread executed by the control section 100 in ACT S13 is described with reference to FIG. 12. The face detection thread is a program executed by the control section 100 for capturing an image of the customer C who is positioned in front of the display section for customer 19 with the camera K6 arranged in the POS terminal 1 and detecting a face from the captured image.

In FIG. 12, the control section 100 activates the camera K6 to start photographing an image of the customer C (ACT S41). Next, the control section 100 stores the captured image of the photographed customer C in the captured image storage section 133 (ACT S42). Then, the control section 100 sends the stored captured image to the server 4 (ACT S43). Next, the control section 100 determines whether or not the face is detected from the captured image (ACT S44). If it is determined that the face is detected (YES in ACT S44), the control section 100 stores the detected facial image of the customer C who executes the transaction in the image storage section 132 (ACT S45).

Next, the control section 100 determines whether or not the control section 100 outputs an under-mentioned end signal of the face detection thread (ACT S46). If it is determined that the end signal of the face detection thread is output (YES in ACT S46), the control section 100 stops the camera K6 to terminate the photographing by the camera K6 (ACT S47).

Further, if it is determined in ACT S46 that the end signal of the face detection thread is not output (NO in ACT S46), the control section 100 returns to the processing in ACT S42. Further, if it is determined in ACT S44 that the face is not detected (NO in ACT S44), the control section 100 executes the processing in ACT S46 without executing the processing in ACT S45.

Return to the description in FIG. 11. On the other hand, if it is determined in ACT S11 that the commodity code is not input (No in ACT S11), the control section 100 declares the end of the transaction, and determines whether or not the deposit/cash total key 171, which is used to carry out a settlement processing with cash in the transaction, is operated (ACT S21). If it is determined that the deposit/cash total key 171 is operated (YES in ACT S21), the control section 100 outputs an end signal for ending the face detection thread that is started in ACT S13 (ACT S22). Next, the control section 100 executes a settlement processing such as depositing cash received from the customer C or dispensing change to the customer C (ACT S23).

Next, the control section 100 determines whether or not the facial image is stored in the image storage section 132 (ACT S24). If it is determined that the facial image is stored (YES in ACT S24), since the face has already been detected, the control section 100 determines attributes (gender, age bracket and the like) of the customer C based on the facial image stored in the image storage section 132 (ACT S25). The control section 100 compares the face parts information stored in the face parts information section 1421 of the face master file 142 with each part (eyes, nose, mouth, ears, jaw, etc.) of the facial image of the customer C stored in the image storage section 132. Then, the control section 100 determines attributes of the customer C based on the comparison result. Specifically, the control section 100 determines the attribute the number of the face parts information of which most similar to those of the facial image stored in the image storage section 132 is most. For example, in a case in which the eye information, the nose information, the mouth information and the ear information included in the face parts information of the facial image stored in the image storage section 132 are similar to those of male in their forties, even if the jaw information included in the face parts information of the facial image stored in the image storage section 132 is similar to that of male in the other age brackets, the control section 100 still determines that the attribute of the customer C is a male in his forties. In a case in which all the parts information is similar to that of a male in his forties, it is determined that the attribute of the customer C is the male in his forties.

Next, the control section 100 stores attribute information indicating the attributes determined in ACT S25 in association with the commodity information stored in the commodity information section 131 in the RAM 13 (ACT S26). Then, the control section 100 sends the stored attribute information and the commodity information to the server 4 (ACT S27). Then, the control section 100 clears, the information in the commodity information section 131, the image storage section 132 and the captured image storage section 133 (ACT S28). The associated information stored in the RAM 13 in ACT S26 is also cleared.

On the other hand, if it is determined that the facial image is not stored in the image storage section 132 (NO in ACT S24), the control section 100 reads out the commodity information stored in the commodity information section 131, and reads out the captured image stored in the captured image storage section 133 (ACT S31). Then, the control section 100 inquires the server 4 based on the read captured image (ACT S32). The control section 100 starts an inquiry thread in FIG. 13. Then, the control section 100 stores the commodity information read out in ACT S31 in the RAM 13 in association with the unknown information indicating that the attributes are unknown (ACT S33). Next, the control section 100 sends the associated commodity information and unknown information to the server 4 (ACT S34). Then, the control section 100 executes a clear processing in ACT S28. Further, in this case, it is not required to clear the associated information stored in the RAM 13 in ACT S33. Then, the control section 100 returns to the processing in ACT S11. Furthermore, if it is determined in ACT S21 that the deposit/cash total key 171 is not operated (NO in ACT S21), the control section 100 returns to the processing in ACT S11.

Next, the inquiry thread started in ACT S32 is described with reference to FIG. 13. In FIG. 13, the control section 100 adds the captured image read out in ACT S31 to perform inquiry of attributes to the server 4 (ACT S51). Next, the control section 100 determines whether or not the attribute information replying to the inquiry in ACT S51 is received (ACT S52). If it is determined that the attribute information is not received (NO in ACT S52), the control section 100 waits for until the attribute information is received. If it is determined that the attribute information is received (YES in ACT S52), the control section 100 associates the received attribute information with the commodity information read out in ACT S31 (ACT S53). In this case, the control section 100 replaces the unknown information associated with the commodity information in ACT S33 with the received attribute information to associate the received attribute information with the commodity information. Then, the control section 100 stores the attribute information associated with the commodity information in the RAM 13. Sequentially, the control section 100 sends the stored attribute information associated with the commodity information to the server 4 (ACT S54). Then, the control section 100 clears the associated information stored in the RAM 13.

Sequentially, a control processing of the server 4 is described with reference to FIG. 14˜FIG. 16. FIG. 14 is a functional block diagram illustrating the functional components of the server 4. The control section 400 respectively realizes functions of a measurement module 401, a reception module 402, an attribute determination module 403 and a sending module 404 according to various programs including the control program 441 stored in the ROM 42 or the memory section 44.

The measurement module 401 has a function of measuring behaviors of a customer in the store based on a captured image of the customer who visits the store by a camera arranged in the store.

The reception module 402 has a function of receiving an inquiry of attributes of a customer from a sales processing apparatus which executes a transaction processing on sales objects sold to the customer in the store.

The attribute determination module 403 has a function of determining attributes of a customer by comparing behaviors of the customer measured by the measurement module 401 with the behavior pattern stored in the storage section if there is an inquiry from the reception module 402.

The sending module 404 sends attribute information indicating the attributes of the customer determined by the attribute determination module 403 to the POS terminal 1.

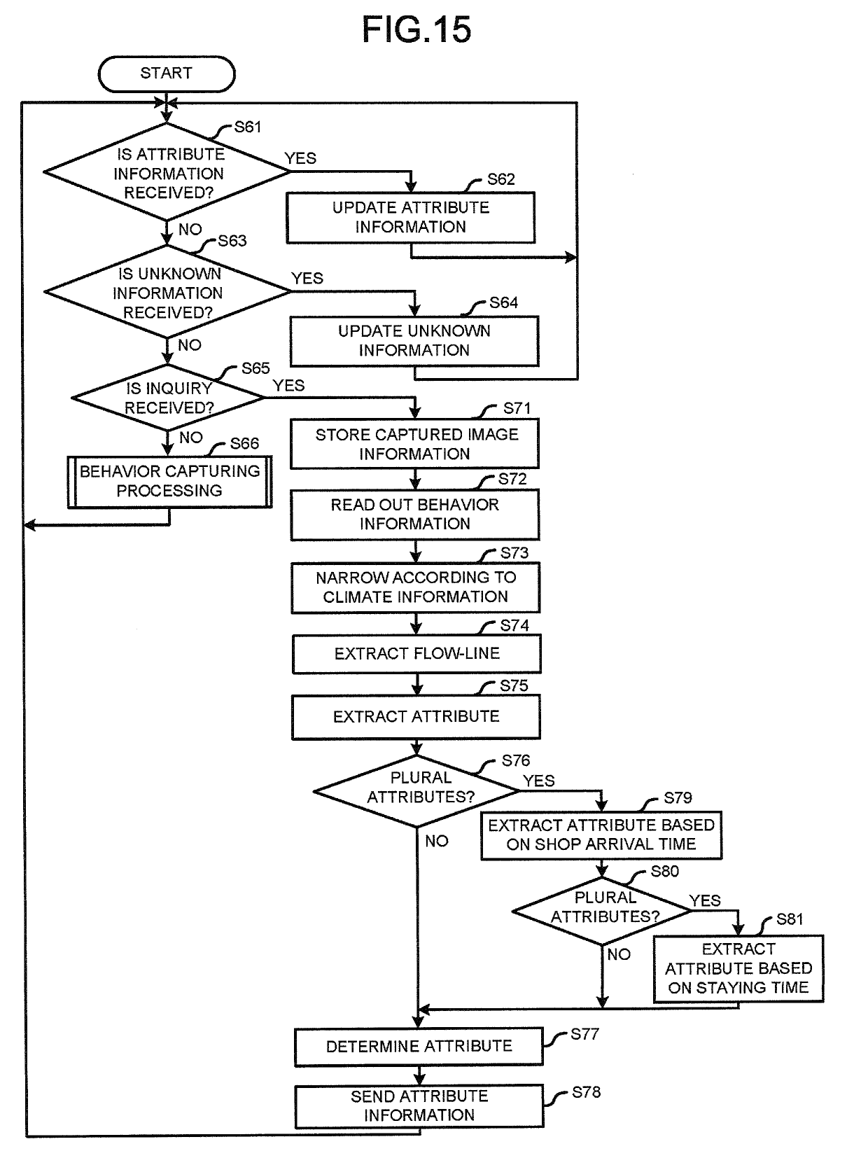

FIG. 15 is a flowchart illustrating the flow of the control processing by the server 4. In FIG. 15, the control section 400 determines whether or not the commodity information and the attribute information in the processing in ACT S27 or ACT S54 are received from the POS terminal 1 (ACT S61). If it is determined that the commodity information and the attribute information are received (YES in ACT S61), the control section 400 updates attribute ratios of the attributes, corresponding to the received commodity information and attribute information, which are stored in the attribute storage section 442 (ACT S62). Within the purchase quantities of commodities stored respectively corresponding to the received commodity information, the purchase quantities of extracted attributes are increased by one, and new attribute ratios are calculated. At this time, the control section 400 decreases the quantity of unknown information stored in the unknown information section 4423 of the attribute storage section 442 in ACT S64 by one in the commodity information of which the attributes are stored. Then, the control section 400 returns to the processing in ACT S61.

Further, if it is determined that the attribute information is not received from the POS terminal 1 (NO in ACT S61), the control section 400 determines whether or not the unknown information in the processing in ACT S34 is received from the POS terminal 1 (ACT S63). If it is determined that the unknown information is received (YES in ACT S63), the control section 400 increases the quantity of the unknown information of the attributes, corresponding to the received commodity information, which is stored in the unknown information section 4423 of the attribute storage section 442, by one (ACT S64). Then, the control section 400 returns to the processing in ACT S61.

On the contrary, if it is determined that the unknown information is not received from the POS terminal 1 (NO in ACT S63), the control section 400 (reception module 402) determines whether or not an inquiry signal of attributes and a captured image in the processing in ACT S51 are received from the POS terminal 1 (ACT S65). If it is determined that they are not received (NO in ACT S65), the control section 400 executes a behavior capturing processing shown in FIG. 16 (ACT S66). Then the control section 400 returns to the processing in ACT S61.

FIG. 16 is a flowchart illustrating the behavior capturing processing executed in ACT S66. In FIG. 16, the face and clothes of the customer C who enters the store through the entrance P3 are captured by the camera K5. Then, the control section 400 determines, based on the captured image, whether or not this customer C newly visits the store or already visits or enters the store (ACT S91). If it is determined that the customer C newly visits the store (YES in ACT S91), the control section 400 (the measurement module 401) counts (measures) a shop arrival time of the customer C (ACT S92). Then, the behavior tracking of the customer C in the store is started. Then, the control section 400 returns to the processing in ACT S91. The determination in ACT S91 by the control section 400 is carried out by determining whether or not the tracking of the customer C is being already started in ACT S93. The control section 400 determines that the customer C already visits or enters the store if the tracking of the customer C is being already started, or determines that the customer C newly visits the store if the tracking of the customer C is not started yet.

On the other hand, if it is determined that the customer C already visits the store (NO in ACT S91), the control section 400 determines whether or not the captured image in the processing in ACT S43 is received from the POS terminal 1 (ACT S101). If it is determined that the captured image is received (YES in ACT S101), the control section 400 terminates the tracking operation started in ACT S93 for the customer in the received captured image (ACT S102). Sequentially, the control section 400 (the measurement module 401) calculates (measures) a staying time of the customer C based on the shop arrival time counted in ACT S92 (ACT S103). Then, the control section 400 (the measurement module 401) analyzes (measures) continuous tracks of behaviors of the customer C in the store from the start of tracking in ACT S93 to the end of tracking in ACT S102 as a flow-line (ACT S104). Then, the control section 400 stores the behavior information (shop arrival time, staying time and flow-line) of the customer C in an associated manner in the behavior storage section 445 (ACT S105).

Return to the description in FIG. 15. In ACT S65, if it is determined that the inquiry signal is received (YES in ACT S65), the control section 400 stores the received captured image in the captured image section 443 (ACT S71). Then, the control section 400 reads out the behavior information (shop arrival time, staying time and flow-line) of the customer C based on the captured image stored in the captured image section 443 (ACT S72). Specifically, the control section 400 recognizes the face (though the face cannot be detected, several parts of the face are captured), and color and shape of the clothes of the customer C based on the captured image stored in the captured image section 443. Then, based on the information of the clothes and the recognized face, the control section 400 selects the corresponding customer C from the behavior storage section 445 and reads out the corresponding behavior information.

Next, the control section 400 reads out today's climate information (season and weather). The today's climate information is stored in the RAM 43. Then, the control section 400 narrows the flow-line patterns stored in the flow-line section, the shop arrival time patterns stored in the shop arrival time section 4442 and the staying time patterns stored in the staying time section 4443 according to the read climate information (ACT S73).

Next, the control section 400 compares the flow-line of the customer C read out in ACT S72 with the flow-line patterns narrowed in ACT S73, and then extracts a flow-line pattern closest to the flow-line read out in ACT S72 from the flow-line patterns narrowed in ACT S73 (ACT S74). Sequentially, the control section 400 retrieves the flow-line section 4441 based on the extracted flow-line pattern to extract a corresponding attribute (ACT S75). Next, the control section 400 determines whether or not there are plural kinds of attributes extracted in ACT S74 (ACT S76). For example, in a case in which the flow-line pattern extracted in ACT S74 is a flow-line pattern A, a plurality of attributes including “male in their teens” and “male in their twenties” is extracted in ACT S75 as a result of retrieving the flow-line section 4441. On the other hand, in a case in which the flow-line pattern extracted in ACT S74 is a flow-line pattern B, an attribute “male in their thirties” is extracted in ACT S75 as a result of retrieving the flow-line section 4441. On the basis of the retrieving result, it is determined whether or not there are plural kinds of extracted attributes in ACT S76.

If it is determined that extracted attribute is one (NO in ACT S76), the control section 400 (the attribute determination module 403) determines that the extracted attribute is the attribute of the customer C (ACT S77). Then, the control section 400 (the sending module 404) sends the determined attribute and the inquiry number to the POS terminal 1 (ACT S78). After that, the control section 400 returns to the processing in ACT S61. In ACT S52, the POS terminal 1 receives the attribute information sent in ACT S78.

On the other hand, if it is determined that there are plural kinds of extracted attributes (YES in ACT S76), the control section 400 retrieves the shop arrival time section 4442 based on the shop arrival time read out in ACT S72. The control section 400 further extracts attributes of people who have the high trend to regard a time zone including the corresponding shop arrival time as a shop arrival time from the plural kinds of attributes extracted in ACT S75 (ACT S79).

Next, the control section 400 determines whether or not there is a plurality of attributes extracted in the processing in ACT S79 (ACT S80). For example, if there is a plurality of attributes having same rate in the processing in ACT S79, there is a case in which the plural kinds of attributes are extracted. If it is determined that only one attribute is extracted (NO in ACT S80), the control section 400 executes the processing after ACT S77. Further, if it is determined that plural kinds of attributes are extracted in the processing in ACT S79 (YES in ACT S80), the control section 400 retrieves the staying time section 4443 based on the staying time read out in the processing in ACT S72. Then, the control section 400 extracts one attribute on which it most tends to regard a time zone including the corresponding staying time as a staying time from the plural kinds of attributes read out in the processing in ACT S79 (ACT S81). Then, the control section 400 executes the processing after ACT S77.

In such an embodiment described above, even if the control section 400 cannot detect the face of the customer C in the POS terminal 1, the control section 400 determines the attribute of the customer C. The attribute information indicating the determined attribute is sent to the POS terminal 1. Thus, even if the face of the customer C cannot be detected, it is possible to determine the attribute information of the customer C. Therefore, the collection of the attribute information of the customer C can be complemented, and can be used as totalization information with more accuracy.

Further, in the embodiment, the control section 400 compares a flow-line of the customer C from a moment when the customer C enters the store to a moment when the customer C carries out a transaction processing with the stored flow-line patterns to determine the attribute of the customer C. Thus, even if the face of the customer C cannot be detected, it is possible to determine the attribute information of the customer C. Thus, the collection of the attribute information of the customer C can be complemented, and can be used as totalization information with more accuracy.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, it is exemplified in the embodiment that the attribute information of the attribute determined by the server 4 is sent to the POS terminal 1, and the attribute information sent from the POS terminal 1 to the server 4 again is stored in association with the commodity information. However, the attribute information may be associated with the commodity information and then stored immediately without being sent from the server 4 to the POS terminal 1.

Further, programs executed by the server 4 of the embodiment is recorded in a computer-readable recording medium such as CD-ROM, FD (flexible disk), CD-R, DVD (Digital Versatile Disk) in the form of installable or executable file to be provided.

In addition, the programs executed by the server 4 of the embodiment may be stored in a computer connected with a network such as an Internet and downloaded through a network to be provided. The programs executed by the server 4 of the embodiment may be provided or distributed via the network such as the Internet.

Alternatively, the programs executed by the server 4 of the embodiment may be incorporated into a ROM and the like to be provided.

What is claimed is:

1. A server which communicates with a sales processing apparatus, comprising:
a storage section configured to store a behavior pattern, which characteristically represents a behavior of a customer who visits a store in the store by an attribute of the customer, for each attribute;
a measurement module configured to measure the behavior of the customer in the store based on an image of the customer captured by a camera arranged in the store;
a reception module configure to receive an inquiry of the attribute of the customer from the sales processing apparatus which executes a transaction processing on a sales object sold to the customer in the store; and
an attribute determination module configure to determine the attribute of the customer by comparing the behavior of the customer measured by the measurement module with the behavior pattern stored in the storage section if the inquiry is received by the reception module.

2. The server according to claim 1, further comprising a sending module configured to send attribute information indicating the attribute of the customer determined by the attribute determination module to the sales processing apparatus.

3. The server according to claim 1, wherein
the behavior pattern stored in the storage section includes a flow-line pattern of a flow-line indicating tracks of the behavior of the customer in the store for a period from a moment when the customer enters the store to a moment the customer performs the transaction processing on the sales objects purchased by the customer with the sales processing apparatus;
the measurement module measures the flow-line of the customer who enters the store; and
the attribute determination module compares the measured flow-line of the customer with the flow-line pattern to determine the attribute of the customer.

4. The server according to claim 3, wherein
the behavior pattern stored in the storage section further includes a shop arrival time pattern, corresponding to an attribute, which indicates a shop arrival time when the customer with the attribute often visits the store;
the measurement module further measures the shop arrival time of the customer who visits the store; and
the attribute determination module further determines the attribute of the customer by comparing the shop arrival time with the shop arrival time pattern if no attribute is determined based on the flow-line of the customer.

5. The server according to claim 4, wherein
the behavior pattern stored in the storage section further includes a staying time pattern, corresponding to an attribute, which indicates a distinctive staying time from a moment when a customer having an attribute visits the store to a moment when the customer performs the transaction processing;
the measurement module further measures the staying time of the customer who visits the store; and
the attribute determination module further determines the attribute of the customer by comparing the staying time with the staying time pattern if no attribute is determined based on the shop arrival time of the customer.

6. A method for determining an attribute of a customer who visits a store with a server, having a storage section for storing for each attribute a behavior pattern which characteristically represents by an attribute of the customer a behavior of the customer in the store, which communicates with a sales processing apparatus, including:
measuring the behavior of the customer in the store based on a captured image of the customer;
receiving an inquiry of the attribute of the customer from the sales processing apparatus which executes a transaction processing on a sales object sold to the customer in the store; and
determining the attribute of the customer by comparing the measured behavior of the customer with the behavior pattern stored in the storage section if the inquiry is received.
